(19) United States
(12) Patent Application Publication
(10) Pub. No.: US 2017/0096132 A1
(43) Pub. Date: Apr. 6, 2017

(54) Slip-Controllable Vehicle Brake System

(71) Applicant: Robert Bosch GmbH, Stuttgart (DE)

(72) Inventors: Heiko Druckenmueller, Mundelsheim (DE); Wolfgang Schuller, Cleebronn (DE); Goekhan Oezkan, Kanagawa (JP)

(21) Appl. No.: 15/312,272

(22) PCT Filed: Mar. 30, 2015
(86) PCT No.: PCT/EP2015/056828

§ 371 Date: Nov. 18, 2016

(30) Foreign Application Priority Data
May 19, 2014 (DE) 10 2014 209 414.3

(51) Int. Cl. B60T 8/40; B60T 8/48; B60T 8/36

(52) U.S. Cl. CPC B60T 8/4068; B60T 8/3655; B60T 8/4872

(57) ABSTRACT

A slip-controllable vehicle brake system includes a brake circuit to which a master brake cylinder is connected to a wheel brake. The connection between the brake circuit and the master brake cylinder is controlled by a changeover valve. To supply the wheel brake with pressure medium, the brake circuit has a pressure generator that is externally driven and interacts with a pressure build-up valve of the wheel brake. The brake system includes a pressure pulsation damping device with a pulsation damper and a resistor which forms a flow cross-section. The pressure build-up valve and/or the changeover valve is continuously adjustable and steplessly switched from an open position into a blocked position. The flow cross-section of the resistor is actualized by an electronic triggering of the pressure build-up valve or the changeover valve such that it is variably adjusted to changing environmental or operating conditions.

### PRIOR ART

The invention relates to a slip-controllable vehicle brake system in accordance with the generic features of claim 1. A vehicle brake system of this type is already known, for example, from DE 10 2010 042 534 A1. Said known vehicle brake system has a brake circuit, to which a brake master cylinder and a wheel brake are connected. A brake pressure can be built up in the wheel brake via an existing pressure medium connection by way of an actuation of the brake master cylinder by the driver. Said pressure medium connection can be interrupted by way of an electronic actuation of a switchover valve, with the result that, as an alternative, a brake pressure build-up in the wheel brake can also be performed by way of a pressure generator which can be driven externally. An electronically actuable pressure build-up valve is connected upstream of the wheel brake, by way of which pressure build-up valve the inflow of pressure medium to the wheel brake can be regulated. In slip-controllable vehicle brake systems, reciprocating piston pumps are frequently used as pressure generators which are actuated by an actuable external drive. Reciprocating piston pumps have a cyclical working principle and generate pressure pulsations in the connected brake circuit. Said pressure pulsations determine the operating noise of the vehicle brake system and can be transmitted into the vehicle interior compartment. The pressure pulsations can also disadvantageously excite undesired vibrations in components, such as a brake pedal which is assigned to the brake master cylinder.

Therefore, pressure pulsation damping devices are used for damping pump pressure pulsations. Said pressure pulsation damping devices are composed in principle of a pulsation damper and a downstream resistance element. The pulsation damper has at least one damper chamber, the volume of which can be varied in a manner which is dependent on the pressure. To this end, the damper chamber is delimited by an elastically deformable or displaceable element, for example a diaphragm, a bellows or a piston which can be displaced counter to the restoring force of an elastic element, for example a spring. The resistance element can be configured as a fixed throttle with a constant flow cross section which impedes the pressure medium flow or what is known as a dynamic throttle with a flow cross section which can be varied in a manner which is dependent on the prevailing pressure.

The relatively high structural complexity for providing the pressure pulsation damping device, its installation space requirement, and its parts and assembly costs are disadvantageous. Moreover, the structural design, once it has been set, of a pressure pulsation damping device influences the dynamics, with which a brake pressure build-up takes place in the vehicle brake system, and cannot be adapted readily to changing environmental conditions of the vehicle brake system, such as to a rising or falling ambient temperature or viscosity of the pressure medium. To this extent, the effective range of a pressure pulsation damping device is dependent on the operating conditions which prevail at the vehicle brake system, and/or the entire potential of a pressure pulsation damping device is utilized merely to a limited extent.

### Advantages of the Invention

In contrast, the invention in accordance with the features of claim 1 has the advantage that the properties of a pressure pulsation damping device can be adapted to the instantaneous operating conditions of the vehicle brake system, without requiring more structural complexity to this end. Rather, in contrast to this, the invention makes it possible to save components, installation space, parts and assembly costs.

According to the invention, the throttle function of a pressure pulsation damping device is assumed by an electronically actuable pressure build-up valve and/or a switchover valve, which are then configured as continuously adjustable valves and can assume an unlimited number of intermediate positions between the open position thereof and the shut-off position thereof as a result. Said intermediate positions can be set in a targeted manner by way of corresponding actuating signals to the valves, with the result that the throttle action of the pressure pulsation damping device can be adapted to the respective operating conditions of the vehicle brake system. For example, the throttle action can be completely suppressed if, for example at a low ambient temperature, the kinematic viscosity of the brake fluid drops to an excessively pronounced extent. As a result of the ability to vary the throttle properties, the pressure build-up dynamics, that is to say the time period until the build-up of a desired brake pressure in the vehicle brake system, can be influenced and can be adapted to the respective requirements of the braking operation, for example a standard braking operation or a braking operation for avoiding a collision with other road users. By way of the invention, different throttle characteristics and/or pressure drop characteristics can be realized, and the noise damping possibilities of a pressure pulsation damping device can be optimized.

Further advantages or advantageous developments of the invention result from the subclaims and/or from the following description.

### DRAWING

Exemplary embodiments of the invention are shown in the drawing and are explained in detail in the following description.

The figures in each case show one exemplary embodiment of a brake circuit which is modified according to the invention of a slip-controllable vehicle brake system, using circuit symbols.

### DESCRIPTION OF THE EXEMPLARY EMBODIMENTS

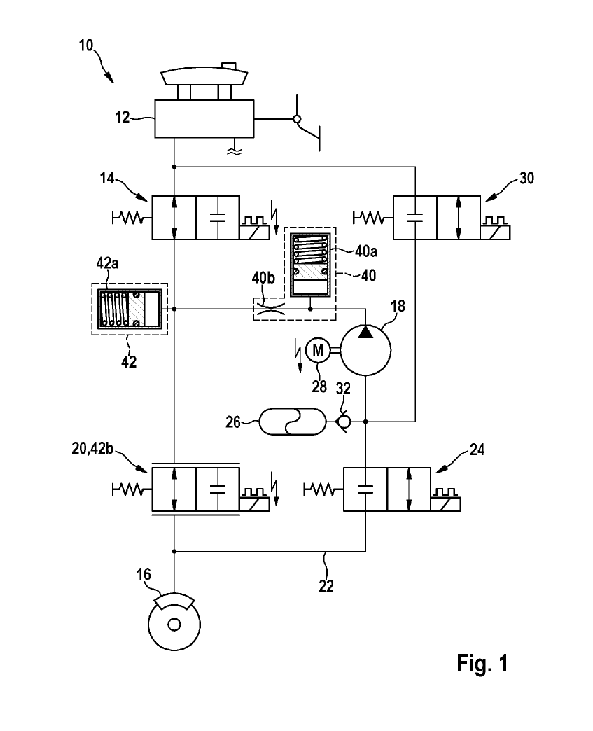

The brake circuit 10 (shown in FIG. 1) of a slip-controllable vehicle brake system is connected to a brake master cylinder 12 which can be actuated by the driver of the vehicle. Said brake circuit 10 comprises a switchover valve 14 which controls a pressure medium connection from the brake master cylinder 12 to a wheel brake 16 of the brake circuit 10. When the brake master cylinder 12 is actuated and the switchover valve 14 is open, a brake pressure build-up in the wheel brake 16 is possible by way of muscle power of the driver, whereas the connection of the driver to the wheel brake 16 can be interrupted by way of shutting off the switchover valve 14, in order to generate the brake pressure by way of external pressure as an alternative. A pressure generator 18 which can be driven externally is connected on the outlet or pressure side to the pressure medium connection from the brake master cylinder 12 to the wheel brake 16. Said pressure generator 18 supplies the wheel brake 16 with pressure medium, a pressure build-up valve 20, inter alia, being connected upstream to regulate the brake pressure of the wheel brake 16.

A return line 22 branches from the pressure medium connection directly upstream of the wheel brake 16. Said return line 22 is provided with a pressure reducing valve 24, in order to control a pressure medium outflow from the wheel brake 16, for the purpose of lowering the brake pressure, if required, for example in the case of an imminent locking risk of the associated wheel. Outflowing pressure medium passes into a buffer store 26 which is arranged downstream of the pressure reducing valve 24 and buffer stores the pressure medium during starting up of the pressure generator 18. After the pressure generator 18 has been started up, it extracts the pressure medium again from the buffer store 26.

In addition, the pressure generator 18 is connected via a separate line section to the brake master cylinder. Said line section has a high pressure switching valve 30 for controlling the connection. The pressure generator 18 sucks pressure medium out of the brake master cylinder 12 in order to build up brake pressure. In order to prevent pressure medium from passing out of the line section downstream of the high pressure switching valve 30 into the buffer store 26, a check valve 32 is provided which makes a throughflow with pressure medium from the buffer store 26 to the suction side of the pressure generator 18 possible, but shuts off the opposite direction to this and therefore interrupts the connection of the line section from the brake master cylinder 12 to the buffer store 26.

As has already been mentioned in the introduction, reciprocating piston pumps are usually used as pressure generator 18. The cyclical delivery principle thereof causes vibrations and pressure waves or pulsations in the brake circuit 10 and ultimately operating noise which can be perceived as disruptive in the vehicle interior compartment. Pressure pulsation damping devices 40, 42 are used in the brake circuit 10 to damp said pulsations. A first pressure pulsation damping device 40, for damping pressure pulsations in a low pressure range up to a fixed pressure limit value, is arranged immediately downstream of the pressure generator 18. A second pressure pulsation damping device 42 which is provided for damping pressure pulsations above said fixed pressure limit value is situated between the switchover valve 14 and the pressure build-up valve 20.

In principle, pressure pulsation damping devices 40, 42 comprise a pulsation damper 40a with a damping chamber, the volume of which can be varied in a manner which is dependent on the pressure, and a resistance element 40b which is arranged downstream of the pulsation damper 40a in the flow direction. Said resistance element 40b throttles an outflow of pressure medium from the pressure pulsation damper 40a and provides a constant resistance or a resistance which can be varied in a manner which is dependent on the pressure to the pressure medium flow, depending on the embodiment. For example, diaphragm dampers with an elastic diaphragm which delimits the variable-volume pressure chamber, bellows dampers with an elastically deformable bellows, or piston dampers with a piston which can be actuated counter to the restoring force of an elastic element can be used as pulsation dampers 40a.

According to the invention, the brake circuit according to FIG. 1 is equipped, inter alia, with a pressure build-up valve 20 which is configured as a continuously adjustable valve, which is shown using the two parallel lines along the longitudinal sides of the corresponding circuit symbol. Continuously adjustable valves differ from conventional switching valves in that they can assume an unlimited number of intermediate positions between an open position and a shut-off position and can therefore assume the action of a throttle or a resistance element in the pressure medium flow. Said different intermediate positions can be set in a targeted manner by way of correspondingly adapted electronic actuation signals to the pressure build-up valve 20, and can therefore be adapted individually to changing operating states and/or ambient conditions of the vehicle brake system. As a result of the provision of a pressure build-up valve 20 which is configured as a continuously adjustable valve, the throttle action of the resistance element 42b of the pulsation damping device 42 is assumed by the pressure build-up valve 20, and the use of a resistance element in the form of a mechanical throttle can be dispensed with. In addition to the parts costs of a mechanical throttle, the costs for assembling it can be saved. The invention therefore proposes to replace a resistance element 42b of conventionally mechanical configuration of the pressure pulsation damping device 42 with an adapted electronic actuation of a continuously controllable pressure build-up valve 20 and therefore with an electronic solution.

The electronic actuation of the components of the brake circuit 10 at the time of effective damping measures is illustrated using the lightning symbols in FIG. 1. If the pressure generator 18 is therefore actuated by way of electrical actuation of its drive 28 and, as a result, delivers pressure medium with the formation of pressure pulsations, the switchover valve 14 which is configured in the manner of a switching valve is at the same time actuated electronically and is switched over into its shut-off position. The propagation of pressure pulsations in the direction of the brake master cylinder 12 is therefore prevented. Furthermore, the continuously controllable pressure build-up valve 20 is loaded with an actuation signal which has been adapted by an electronic control unit in such a way that the pressure build-up valve 20 firstly carries out an adaptation of the pressure in the wheel brake 16 to the slip conditions which prevail at the associated wheel and secondly carries out throttling of the pressure medium flow which flows to the wheel brake 16, within the context of its function as a resistance element 42b of a pressure pulsation damping apparatus 42.

By way of electrically controlled throttling of the pressure medium flow to the wheel brake, pulsations which are caused in the high pressure region of the brake circuit 10 by way of the operation of the pressure generator 18 are damped effectively and the noise behavior of the vehicle brake system is improved considerably.

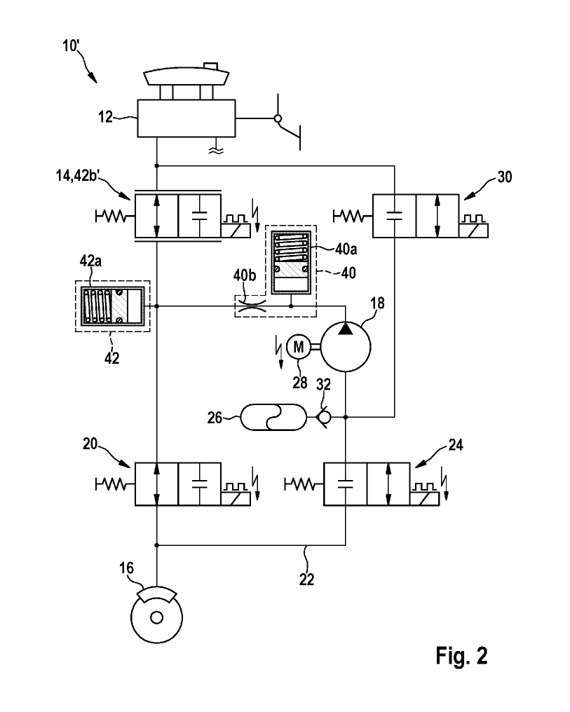

With a few exceptions, the exemplary embodiment according to FIG. 2 is of identical configuration to the exemplary embodiment according to FIG. 1. Components of the brake circuits which correspond to one another are therefore provided with uniform designations. The brake circuit 10′ according to FIG. 2 differs, in particular, in that a conventional switching valve is now used instead of a pressure build-up valve 20 which is configured as a continuously adjustable valve, whereas the switchover valve 14 is now no longer configured as a switching valve, but rather as a continuously adjustable valve, shown using parallel lines along the longitudinal sides of the symbol, and can assume an unlimited number of intermediate positions.

By way of a switchover valve 14 which is configured as a continuously adjustable valve, the throttle function of the resistance element 42b′ of the pressure pulsation damping device 42 is then transferred to the switchover valve 14 which, as a result, damps pressure pulsations in a path to the brake master cylinder 12. The operating noise of the vehicle brake system can also be lowered by way of damping of said brake master cylinder path and, above all, no vibrations or at least considerably attenuated vibrations occur at the pedal of the brake master cylinder 12.

In order to achieve the damping action, the pressure build-up valve 20 is also actuated electronically in the case of an actuated drive or delivering pressure generator 18, symbolized using a lightning symbol. Said pressure build-up valve 20 thereupon switches over into its shut-off position. Furthermore, electronic actuation of the pressure reducing valve 24 takes place, which pressure reducing valve 24 is switched over into the open position as a result. The described second pressure pulsation damping device 42 can selectively be operated without a first pressure pulsation damping unit 40 or in series with, for example, a first pressure pulsation damping device 40 which is connected directly downstream of an outlet of the pressure generator 18. The first pressure pulsation damping device 40 is advantageously designed for damping pressure pulsations which occur at relatively low pressures of the pressure generator, that is to say up to the fixed pressure limit value, and can therefore also be called a low pressure pulsation damping device.

An adaptation of the first pressure pulsation damping device 40 to the lower brake pressures to be damped takes place, inter alia, by way of elastic elements (diaphragm, bellows, restoring element) of smaller dimensions and a resistance element 40b with a larger flow cross section. The dimensions thereof are adapted to the design of the elastic elements.

It goes without saying that amendments of or additions to the described exemplary embodiments are possible, without departing from the basic concept of the invention.

1. A slip-controllable vehicle brake system, comprising:
a brake circuit with at least one wheel brake;
a pressure generator and a pressure build-up valve configured to supply the wheel brake with a pressure medium;
a switchover valve configured to control a pressure medium connection of the brake circuit to a brake master cylinder of the vehicle brake system; and
a pressure pulsation damping device arranged downstream of the pressure generator, the pressure pulsation damping device having a resistance element with a flow cross section that impedes a pressure medium flow,
wherein one or more of the pressure build-up valve and the switchover valve is configured as a continuously adjustable valve that is configured to be changed over in a controlled manner from an open position into a shut-off position via an unlimited number of intermediate positions by way of electronic actuation, and
wherein the flow cross section of the resistance element of the pressure pulsation damping device is formed by the one or more of the pressure build-up valve and the switchover valve by way of an electronic actuation, adapted to the flow cross section, of the one or more of the pressure build-up valve and the switchover valve.

2. The slip-controllable vehicle brake system as claimed in claim 1, wherein the pressure pulsation damping device has a pulsation damper with a damper chamber, a volume of the damper chamber configured to be varied in a manner that is dependent on the pressure.

3. The slip-controllable vehicle brake system as claimed in claim 2, wherein the pulsation damper is arranged in the region between the switchover valve and the pressure build-up valve of the brake circuit.

4. The slip-controllable vehicle brake system as claimed in claim 1, wherein:
at the time of the actuation of the pressure build-up valve for configuring the flow cross section that impedes the pressure medium flow, the switchover valve assumes its shut-off position, or
at the time of the actuation of the switchover valve for configuring the flow cross section that impedes the pressure medium flow, the pressure build-up valve assumes its shut-off position.
